(19) United States
(12) Patent Application Publication
(10) Pub. No.: US 2006/0059422 A1
(43) Pub. Date: Mar. 16, 2006

(54) Desktop application implemented with web paradigm

(76) Inventors: Ting-Hu Wu, Fremont, CA (US); Limin Hu, Fremont, CA (US); Tsu-Wang Chen, Fremont, CA (US)

Correspondence Address: DERGOSITS & NOAH LLP, Suite 1450, Four Embarcadero Center, San Francisco, CA, 94111, US

(21) Appl. No.: 10/943,675

(22) Filed: Sep. 16, 2004

(51) Int. Cl. G06F 17/30

(52) U.S. Cl. 715/513

(57) ABSTRACT

A program module that serves as a dispatcher for client-side desktop applications that use web-based markup language as a graphic user interface to access both web resources and execute local functionalities is described. An embedded browser component within a desktop application allows the client computer to host markup language forms and interact with other web resources. The forms and resources can reside on the client computer or any other networked remote or server computer. The embedded web browser is functional as a stand-alone web browser as well as an interface adapter for the desktop application. Desktop application files or forms can be modified without recompilation of the underlying application code, and the adaptation of the desktop application interface to the web browser interface provides a consistent user interface design for both the desktop and web applications.

### FIELD OF THE INVENTION

The present invention relates generally to application program software, and more specifically, to desktop applications that incorporate web browser interface technology and user interface paradigms.

### BACKGROUND OF THE INVENTION

The use of the Internet for providing a platform for a wide host of transactional systems has led to a widespread acceptance of the web browser paradigm as a familiar graphical interface for many, if not most computer users. The traditional web browser interface, such as that exemplified by Microsoft® Internet Explorer™ or Netscape® Navigator™, typically provides a standard set of icons that allows a user to view, close, and edit a document, or navigate among different documents (pages) within a file. The main user interface to files and resources on the World Wide Web is provided by “web pages” that are served by a web server process on a server computer and viewed by a web browser process running on a client computer. The universal format for data on the World Wide Web is the Standard Generalized Markup Language (SGML). The Hypertext Markup Language (HTML) is a subset of SGML and contains markup symbols to describe the contents of a page or file. HTML specifies how the text and graphic images of a web page are displayed or interacted with by other programs, instructions, or data. A complementary subset to HTML is the Extensible Markup Language (XML). This language enables the definition, transmission, validation and interpretation of data among different applications over the World Wide Web.

Despite large-scale efforts to port many computer applications to the Internet using a distributed client/server program model, many applications are more efficiently executed as local or “desktop” applications, which reside and execute only on the client computer. Such programs are either inappropriate for network implementation and use, or simply do not benefit from a distributed client-server computing paradigm. Under certain circumstances, however, these stand-alone desktop applications may be used in heterogeneous environments in which web-based data or programs may be implemented. In such cases, it may be desirable to provide a common user interface, so that user interaction between the desktop application and web-based applications can be performed in a seamless manner.

At present, various solutions exist to allow the conversion of object-oriented applications to Markup Language interfaces. One such solution is described in U.S. Pat. No. 6,504,554 entitled “Dynamic Conversion of Object-Oriented Programs to Tag-Based Procedural Code.” These systems, however, typically provide only a means to convert a file or program for access through a web browser. Such systems do not provide a web-based interface to stand-alone desktop functionalities, nor do they provide portability between the desktop application and web-based applications.

What is needed, therefore, is a system that allows the adaptation of one or more desktop applications operating locally under an operating system, such as Microsoft® Windows™, to a markup language format as a web-based interface to provide both web and local functionalities for the desktop application.

### SUMMARY OF THE INVENTION

A software module for client-side desktop applications that use a web-based markup language as a graphical user interface (GUI) to access both web resources and execute local functionalities is described. In one embodiment of the present invention, an embedded browser component within a desktop application allows the client computer to host markup language (e.g., HTML) forms and interact with both web resources and local computing resources. The forms and local resources can reside on the client computer or any other networked remote or server computer. The embedded web browser is functional as a stand-alone web browser as well as an interface adapter for the desktop application. User selection of a URL link within the desktop application results in a web navigation operation or a local function call, or both. The use of a web-based markup language as a desktop application program user interface allows easy modification of the application user interface or forms without recompilation of the underlying application code. The adaptation of the desktop application interface to the web browser interface also provides a consistent user interface design for both the desktop and web applications. Users of the application will be provided with identical visual presentation and access/navigation command structure for both standalone desktop applications and web pages. The use of a web-based GUI paradigm allows convenient portability of desktop applications to web server environments to provide ASP (Application Service Provider) solutions.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a client computer executing an HTML-based graphical user interface for desktop applications within the context of a distributed network, according to one embodiment of the present invention;

FIG. 2A is a block diagram illustrating an HTML graphical user interface adapter for desktop applications, according to one embodiment of the present invention;

FIG. 2B is a block diagram illustrating an HTML graphical user interface adapter for desktop applications, according to an alternative embodiment of the present invention;

FIG. 3A is a flowchart that illustrates the steps of adapting a desktop application to an HTML-based graphical user interface, according to a method of the present invention;

FIG. 3B is a flowchart that illustrates the steps of adapting a desktop application to an HTML-based graphical user interface, according to an alternative method of the present invention;

FIG. 4 is an exemplary web page for an adapted desktop application, according to one embodiment of the present invention; and

FIG. 5 illustrates a three-tier web paradigm interface for application programs, according to one embodiment of the present invention

### DETAILED DESCRIPTION OF THE PREFERRED EMBODIMENT

A method and system for incorporating a markup language based graphical user interface for desktop applications is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, or any other similar type of computing device.

In a network embodiment of the present invention, a client computer is configured to execute one or more local (or “desktop”) applications. Such applications may reside locally or they may be downloaded over the network for local execution. In either case, the desktop application is executed solely on the client computer. Resulting data or output may then be stored locally and/or transmitted to other computers over the network. The client computer may also execute a web browser program that allows a user to access web pages over the World Wide Web (“web”) portion of the Internet.

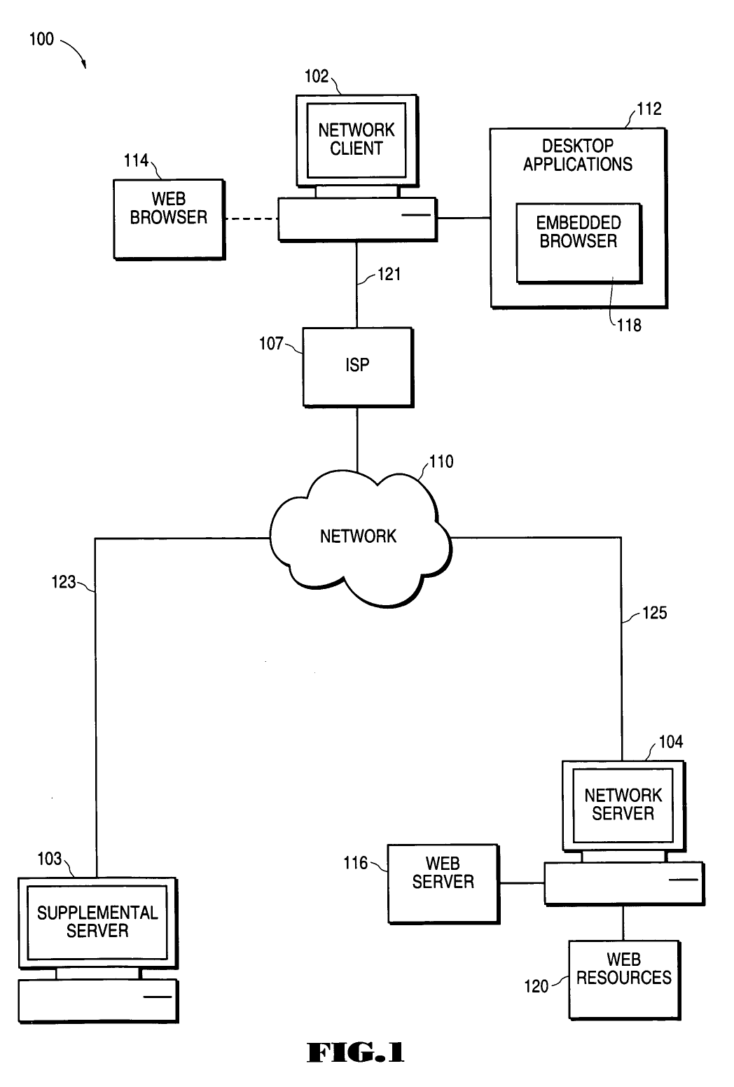

FIG. 1 illustrates an exemplary network system 100 that includes a client computer executing an adapter for providing an HTML-like interface for desktop applications, according to one embodiment of the present invention. In FIG. 1, a client computer 102 executes one or more desktop applications 112. The user interface for these applications may be proprietary or they may be designed in accordance with requirements of the operating system being used. For example, the more popular PC operating systems such as MS-Windows™, Linux™, and the Apple® OS, encourage or even require applications to implement a user interface that contains certain pre-defined components so that uniformity among applications is ensured.

In one embodiment, the client computer 102 contains a network interface that provides access over a network 110. For the embodiment in which the network comprises the Internet, the client 102 typically accesses the network through an Internet Service Provider (ISP) 107 and executes a web browser program 114 to display web content through web pages. In one embodiment, the web browser program is implemented using Microsoft® Internet Explorer™ browser software, but other web browser programs may also be used. Network 110 couples the client computer 102 to one or more server computers 104. For a web-based interface, the server computer 104 executes a web server process 116 that serves web content in the form of web pages to the client computer 102. Other web resources 120, such as file download sites, may also be accessible through server 104. In addition, the system 100 may also include other networked servers, such as supplemental server 103, which provide on-line services, data, and/or resources.

In one embodiment of the present invention, the client computer 102 is configured to execute one or more desktop applications 112. These typically comprise application programs, such as word processors, database applications, and so on, that are stored and executed locally on the client computer. Although these programs may use data or program modules that are available over the network 110, they are usually executed and store data exclusively on the client computer. For desktop applications in which an HTML compatible interface is to be provided, an embedded web browser component 118 is included within the application program. The embedded web browser 118 can be configured to function as a stand-alone web browser to interface with a web server process 116 on a server computer 104. In general, however, it is configured to provide an HTML interface for the desktop application 112. The embedded web browser 118 allows the desktop application to host HTML forms and documents, and to interact with other web resources. The forms, documents, and resources can reside on the network client or on a remote computer, such as server 104.

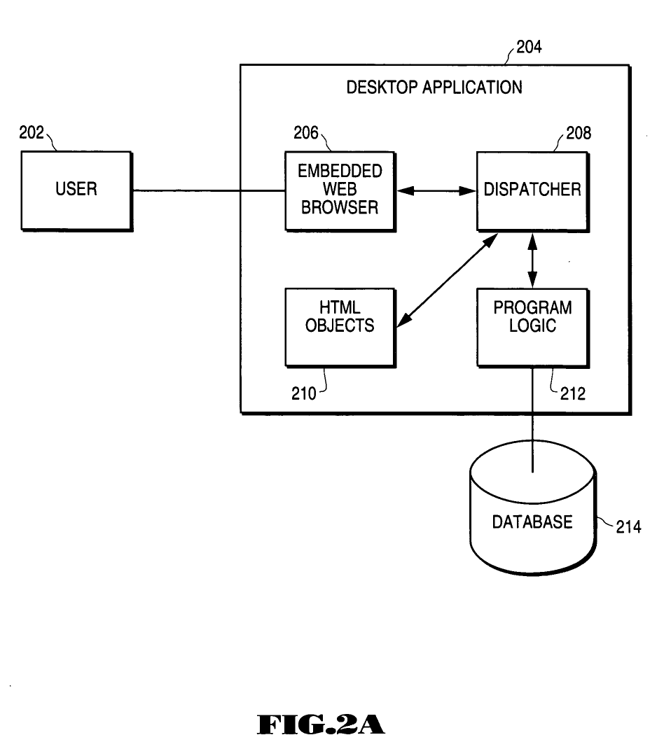

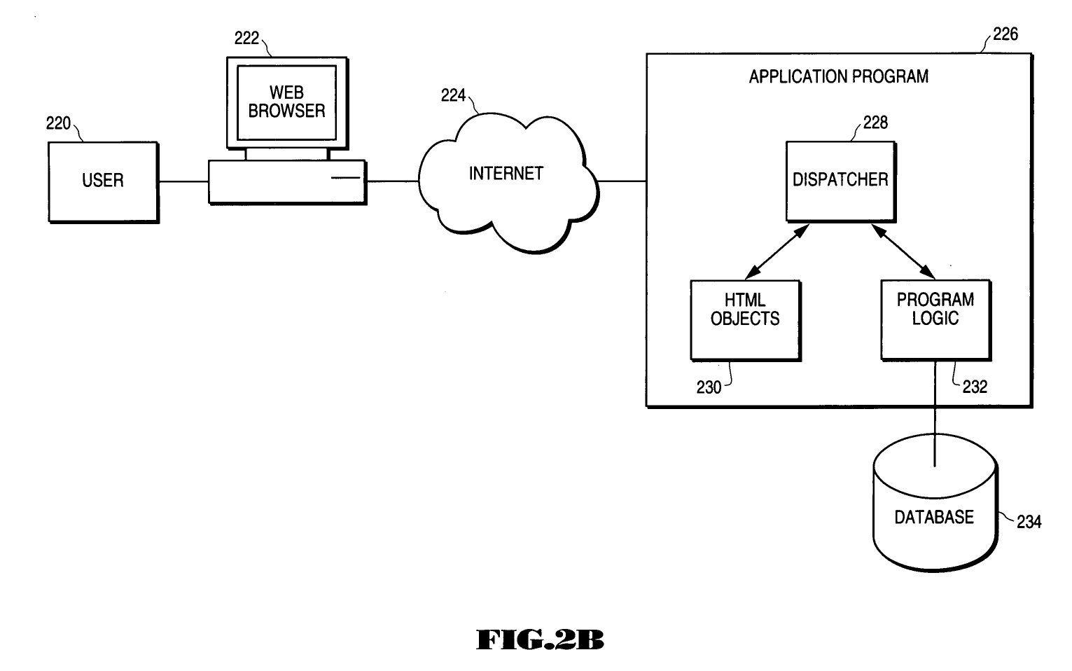

FIG. 2A is a block diagram that illustrates an application program that implements an HTML graphical user interface paradigm to access both web-based resources and local program resources, according to one embodiment of the present invention. A user 202 interfaces with desktop application 204 to perform various program functions that are controlled by program logic modules 212. The program logic 212 interacts with database 214 to provide data processing or other data manipulation required by the desktop application 204. Such data can comprise stored text or numeric data, graphic data, data objects, and any other type of data used by the application program 204. Similarly, the program logic 212 can comprise arithmetic or logic functions that are used by the application 204 to retrieve, modify, store, and/or transmit data within database 214.

The interface between the user and the application is defined by the graphical appearance of the program on the client display as well as the input and output of data between the user and the application. Typical stand-alone or true desktop applications that are designed to execute and operate locally on a single client (or server) computer usually provide a unique user interface that is defined by the manufacturer of the application. For example, database applications manufactured by the leading database software publisher can provide a user interface that is unique to that publisher's product line. If a different database program is used, the user interface “look and feel” can be entirely different, even though similar operations may be executed, and similar data operated upon. The graphical user interface is thus an important and usually distinctive feature of most application program, and can substantially define the user's experience with a software product.

The emergence of the web browser as a commonly used application has resulted in the emergence of a general user interface that many users all over the world are becoming increasingly familiar with. The user interfaces provided by different application programs, however, are usually unique and can be quite different from the more familiar web browser or common operating system interfaces, such as the widely used MS-Windows™ system.

For the embodiment illustrated in FIG. 2A, the desktop application incorporates a user interface “front-end” that provides the look and feel of either the familiar web browser interface or the Microsoft® Windows™ application interface. The desktop application 204 includes an embedded web browser component 206 that interfaces directly with the user 202. The desktop application 206 may also include a number of HTML objects that codify various interface or logic modules acted upon by the embedded web browser 206. The embedded web browser 206 is functionally interfaced to a dispatcher module 208 within the application program 204. In one embodiment of the present invention, the application program 204 includes hidden information or undocumented attributes that are transparent to the embedded web browser 206. This hidden data is stored in the HTML objects file 210. Thus, the HTML files 210 contain additional information to be used by the dispatcher module 208.

The hidden data, which can be either undocumented attributes or any object, data structure or command that is transparent to the browser is recognized by the dispatcher and acted upon as required. These attributes are ignored by the web browser program, so the user will not perceive any difference between the HTML page displayed by the embedded web browser and any other HTML page. Furthermore, custom objects can be implemented to support specific system or product user interfaces, such as the Microsoft® application user interface.

The dispatcher module 208 uses the hidden information contained in the application program on two separate occasions. First, before the embedded browser 206 displays an HTML page, the dispatcher examines the page to determine whether there are any specific operations or commands to be executed. For example, the dispatcher may overlay an HTML page with input fields and data retrieved from data storage 214 through program logic 212 before it passes it to the browser. The hidden attributes in the HTML page instruct the dispatcher 208 where and what those input fields are and what type of information is expected. In the second case, the dispatcher module 208 intercepts user events or commands and inspects these events against the hidden information in the page. For example, when the user navigates the HTML page, he or she may enter data into the input fields or click a hypertext link. These navigational or data entry events are intercepted and examined. If extra processing is called for, the dispatcher invokes the program logic 212 inside the program, or within a remote server, to do the calculation or data retrieval. The dispatcher may then create a new HTML page to pass back to the browser 206. Otherwise, the dispatcher simply passes the control back to the browser 206. For the embodiment illustrated in FIG. 2A, the web browser functionality is embedded within the application program, such as is illustrated in FIG. 1 with embedded browser 118 within application 112. For this embodiment, the standalone web browser 114 is not required.

FIG. 2B illustrates an alternate embodiment of the present invention in which the web browser function is not embedded within the desktop application program, but is instead provided by a standalone web browser program, such as browser 114 shown in FIG. 1. As shown in FIG. 2B, the user executes web browser 222, which accesses the application program 226 over the Internet 224. The application program 226 includes hidden HTML objects 230 that are acted on by dispatcher 228. Program logic 232 is also controlled by dispatcher 228 to interface with data stored in database 234, as necessary. The operation of the dispatcher with regard to data and command manipulation, and user navigation around the application program is identical with the process describe above for FIG. 2A, the primary difference being that the web browser 222 functionality is decoupled from the application program 226.

In FIG. 2A, the embedded web browser component 206 within the desktop application 204 effectively integrates the application within the context of the web interface without requiring full integration of the application as a true networked program. The graphical user interface is adapted to appear identical to that of a web page served by web server 116, and data within the application is formatted to interact with other web resources 120. Moreover, data and data structures can be seamlessly exported in the form of HTML forms from and to the application program. The application program remains as a locally stored and executed program, however the data and interface are adapted for use within a web-based context. In this manner, the program data is presented to the users in HTML files, and communication between clients and server is HTTP-based. For this embodiment, forms and data to other networked clients can be submitted in PDF/plain text format.

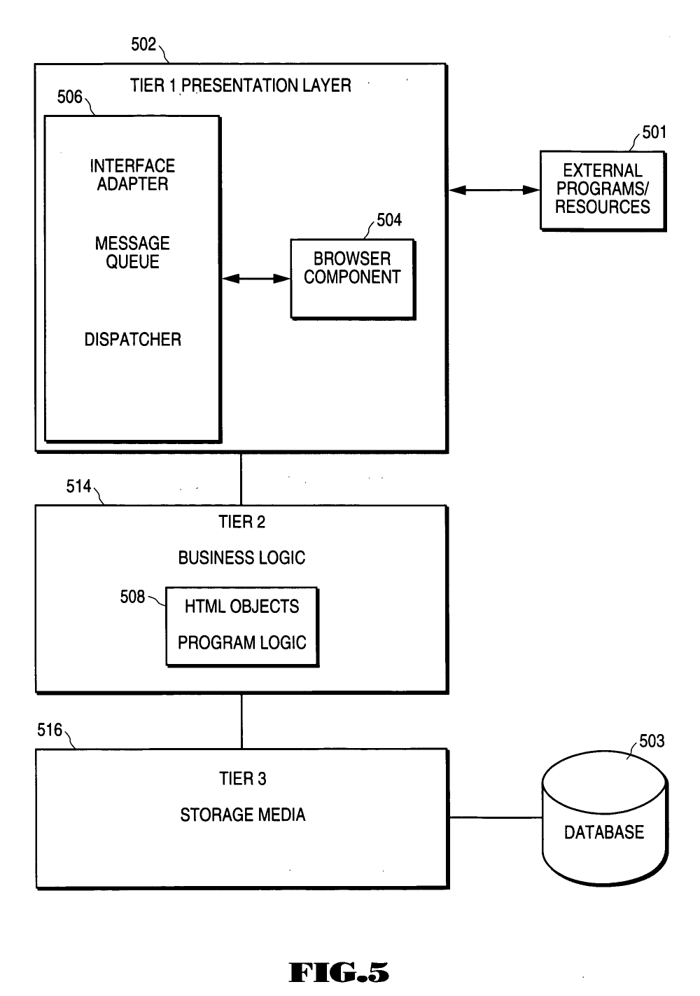

For the embodiment illustrated in FIG. 2A, the embedded web browser includes software modules that adapt the user interface component of the application program 112 to conform to the standard user interface used by the web browser 114. In one embodiment, the implementation of the web paradigm for the application program is performed using a three-tier approach. This allows the application to be ported to a full web version with little modification to support the web-based ASP (Application Service Provider) model. In general, an ASP is a third-party entity that manages and distributes software-based services and solutions to customers across a wide area network from a central data center. FIG. 5 illustrates the three-tier web paradigm interface for application programs, and an alternative representation of the functional architecture of the system illustrated in FIG. 2A.

As illustrated in FIG. 5, the application program includes a presentation layer 502 (tier 1), which provides the graphical user interface functionality; a business logic layer 514 (tier 2) that dictates the input/output and processing of data; and a storage media layer (tier 3) that includes modules which allow the application tier to write and pull data to and from databases and file storage repositories. Such databases can be stored on local or remotely coupled storage devices, such as disk, tape or optical drives 503.

In one embodiment, the presentation layer includes an embedded web browser component 504 that is coupled to an interface adapter, message queue, and dispatcher module 506. The interface adapter takes GUI definitions and data output from the business logic component 514 of the application program and adapts the user interface and output data to a predefined format. This format is typically defined to conform to the design and style of a standard web browser. The message queue process associates incoming messages with pre-defined functional components, is used to associate the interface components with HTML data structures. The dispatcher interprets hidden commands or attributes within the application program and executes the commands and/or navigational functions in a manner that is transparent to the user.

The first tier 502 is the incorporation of embedded web browser control within the application, in an embodiment referred to a “fat client” implementation. In this version, the application is a super set of traditional browser modules 504 and the desktop application 506, and can interact with local or remote resources 501 (such as web pages served by external web servers) through the dispatcher. The dispatcher module receives instructions from the message queue and either sends the request to the browser component 504 for navigation within the program, or sends the request to the business logic tier 514 for further processing. The dispatcher can also communicate with an external resource 501, such as a remote web server to download programs for local execution, such as DLL/EXE code.

As illustrated in FIG. 5, the second tier of the architecture is a business logic tier 514. This tier acts as the intermediary between the application tier 502 and a storage media tier 516, and includes the HTML objects that comprise the hidden attributes that are interpreted by the dispatcher, as well as the program logic that acts on the data stored in database 503.

In one embodiment of the present invention, the application uses HTML/SGML modules as the graphical user interface components and any forms or document definitions, as opposed to forms used in traditional Windows or Linux, or other operating system interfaces. This provides a consistent experience between manipulating the application program and navigating through web pages on the Internet. It also gives the user the capability to modify or revise the forms within the program without requiring re-compiling of the program source code. For the first tier embodiment, the HTML links on the forms used by the application are implemented as either HREF URL links, or as special signature links. In general, an HREF link is a Hypertext Reference and is used as an attribute in a link to signify the network location to which the link points. In this case, if the link is selected (clicked on) by the user, the application will operate like a web browser and navigate to that page in the program. For the embodiment in which a special signature link is used, this link instructs the application to interact with the second tier (business application tier) 514 to perform the necessary program tasks. The application monitors any user input, such as text input, mouse clicks, page navigation, and so on to interact with the business logic tier to perform tasks required by the program.

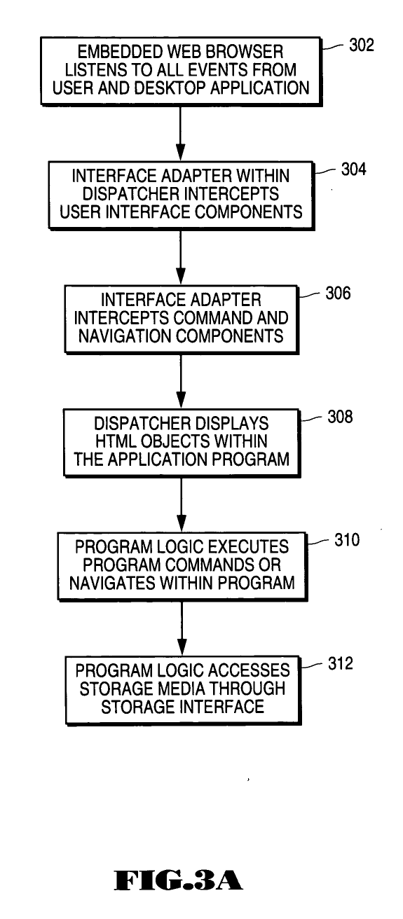

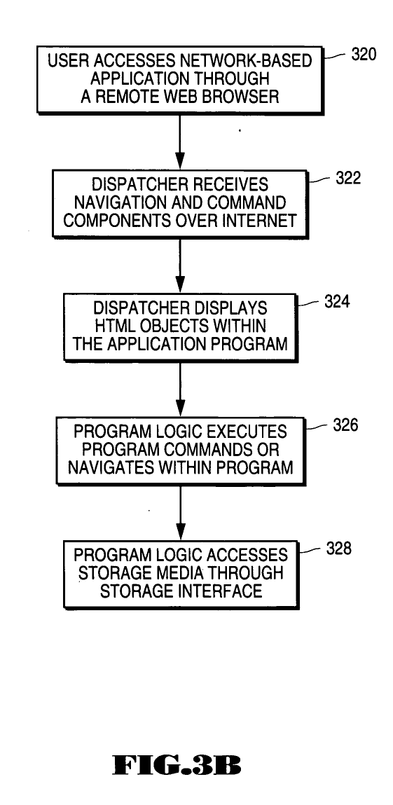

FIG. 3A is a flowchart illustrating the steps of adapting a desktop application to an HTML based interface, according to one embodiment of the present invention, and specifically for the embodiment illustrated in FIG. 2A. In step 302 of process 300, the embedded web browser listens to all events from the desktop application. Such events may include the input or output of data from the user or other processes within the client computer, and typically do not include any processing tasks within the program itself. The interface adapter within the embedded web browser intercepts all user interface components within the desktop application, step 304. The interface adapter also intercepts all command and navigation components within the desktop application, step 306. The message queue process then associates these interface components with HTML data structures. These data structures are then used to create an HTML-based graphical user interface overlay for the desktop application. In step 308, the dispatcher displays the non-hidden HTML objects that are contained within the application program. The program logic module executes any program commands or navigates within the program, step 310. The program logic then accesses the storage media through the storage interface, to act on any data required by the application program, step 312.

For the embodiment illustrated in FIGS. 2A and 3A, once the graphical user overlay is created, the interface for the application program is adapted to appear identically to that of the resident web browser program 114. This graphical user interface can be designed to follow wither the web interface or the Microsoft® Windows™ user interface. This allows the presentation as well as import/export of data between the desktop application and web browser to be performed in a virtually seamless manner. It also allows the use of certain web utilities such as form fill techniques, history logging, and other web-based resources. In one embodiment of the present invention, the embedded web browser 118 functions as an input process for the application program. The browser 118 acts to input HTML data, such as forms, which are then acted on locally by the application program 112. This allows the forms to function as a dynamic component that is acted on by the application program, as opposed to static forms served by the web server and displayed by the web browser.

FIG. 3B is a flowchart illustrating the steps of adapting a desktop application to an HTML based interface, according to an alternative embodiment of the present invention, and specifically for the embodiment illustrated in FIG. 2B. For this embodiment, the user accesses the network-based application through a remote web browser, such as browser 222, step 320. The dispatcher 228 receives navigation and command information over the Internet network, step 322. The dispatcher displays the non-hidden HTML objects within the application program through the web browser 222, step 324. The program logic executes the program commands or navigates within the program, step 326, and the program logic module access the storage media through the storage interface, step 328.

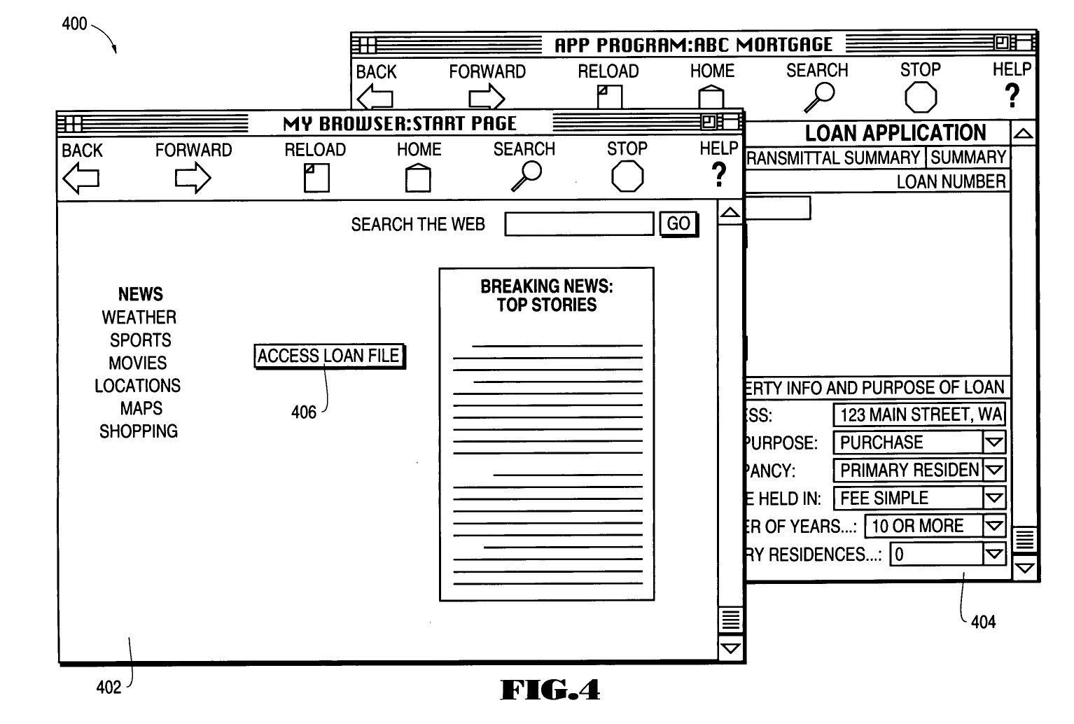

FIG. 4 illustrates the display of a standard web page along with an adapted desktop application, according to one embodiment of the present invention. As shown in display 400, a typical web page 402 containing a navigation command bar and document control icons is provided through web browser 114. Also shown in display 400 is a window for a desktop application that is executed locally on client computer 102. The adaptation of the GUI for this application produces an interface that is identical to that of web page 402. Although the interface is the same, the application illustrated in window 404 is a locally executed application, and not a web page accessed over the Internet.

As shown in FIG. 4, the application program window 402 can include a navigation control button 406. In this case, the navigation button “Access Loan File” allows the user to access a loan file for a customer. Such a loan file can be displayed on a separate web page 404. The application program that creates and maintains the loan file can be a standalone or networked loan application program. In this case, the user interface, navigational commands and data access are performed by a dispatcher interpreting hidden commands within the application program. The web browser user interface is provided by an embedded web browser, while the execution of commands and navigation is provided using a web browser paradigm through the interaction of the dispatcher, HTML objects, and business logic.

Although specific embodiments of the present invention were described with reference to HTML data structures, it should be understood that other markup languages, such as XML or other subsets of SGML now or subsequently developed can also be used with alternative embodiments of the invention.

In the foregoing, a system has been described for adapting the interface for desktop applications to web-based displays. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A computer-implemented method for adapting an application program executed on a client computer to a web-based interface, the method comprising:
linking an embedded web browser module to an executable portion of the local program;
extracting graphical user interface components of the application program;
associating the graphical user interface components with markup language data structures; and
overlaying a markup language compatible user interface over the local application program to adapt the application program graphical user interface to be compatible with a web browser application resident on client computer.

2. The method of claim 1 wherein markup language comprises at least one of a Hypertext Markup Language and an Extensible Markup Language.

3. The method of claim 1 wherein the step of extracting the graphical user interface components of the application program further comprises the step of intercepting input/output messages to and from the client computer during a data transfer between the client computer and a remote computer coupled over a network.

4. The method of claim 3 wherein the network comprises the World-Wide Web portion of the Internet.

5. A system for providing a web-based interface for a computer application program, comprising:
an application layer including an embedded web browser module within the application program, an interface adapter, a message queue, and a dispatcher; and
a business logic layer functionally linked to the application layer; and
a storage media interface layer functionally linked to the business logic layer.

6. The system of claim 5 wherein the dispatcher transmits commands to the embedded web browser to navigate through the application program.

7. The system of claim 5 wherein the dispatcher transmits commands to the business logic layer for further processing of commands by the application program.

8. The system of claim 5 wherein the application layer transmits and receives commands and data to and from one or more external resources, the external resources including one or more remotely coupled computing devices executing external programs.

9. The system of claim 5 wherein the storage media interface layer is coupled to one or more physical storage devices storing databases.

10. The system of claim 5 further comprising forms used by the application program, and wherein the forms include one or more navigational links utilized by the application program, each navigational link providing ability for the user to navigate among the forms through an interface that simulates web-based navigation.

11. The system of claim 10 wherein the one or more navigational links comprise Hypertext Reference Uniform Resource Locator links.

12. A computer-implemented method for adapting an application program executed on a client computer to a web-based interface, the method comprising:
embedding a web browser within a desktop application program;
incorporating hidden attributes within the desktop application program;
intercepting user commands through a dispatcher module functionally coupled to the embedded web browser;
displaying non-hidden HTML data objects through the embedded web browser within the desktop application program;
performing program routine jumps through the application program in accordance with navigational commands issued by the user; and
performing logic operations in the application program in accordance with operational commands issued by the user.

13. The method of claim 12 further comprising the step of providing access to one or more forms used by the application program, and wherein the forms include one or more navigational links utilized by the application program, each navigational link providing ability for the user to navigate among the forms through an interface that simulates web-based navigation.

14. A computer-implemented method for adapting an application program executed by a user of a networked client computer to a web-based interface, the method comprising:
accessing an application program on a server computer through a web browser executed on the client computer;
incorporating hidden attributes within the application program;
intercepting user commands through a dispatcher module within the application program;
displaying non-hidden HTML data objects through web browser on the client computer;
performing program routine jumps through the application program in accordance with navigational commands issued by the user; and
performing logic operations in the application program in accordance with operational commands issued by the user.

15. The method of claim 14 further comprising the step of providing access to one or more forms used by the application program, and wherein the forms include one or more navigational links utilized by the application program, each navigational link providing ability for the user to navigate among the forms through an interface that simulates web-based navigation.
